(19) United States
(12) Patent Application Publication
(10) Pub. No.: US 2005/0214501 A1
(43) Pub. Date: Sep. 29, 2005

(54) Waterproof/breathable technical apparel

(76) Inventor: Baychar, Eastport, ME (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/098,639

(22) Filed: Apr. 5, 2005

Related U.S. Application Data
(63) Continuation-in-part of application No. 08/910,115, filed on Aug. 13, 1997.
Application No. 08/910,115 is a continuation-in-part of application No. 08/832,815, filed on Apr. 4, 1997, now abandoned.
Application No. 08/832,815 is a continuation-in-part of application No. 08/747,340, filed on Nov. 12, 1996, now Pat. No. 5,738,937.
(60) Provisional application No. 60/559,009, filed on Apr. 5, 2004.

(51) Int. Cl. B32B 5/18; B32B 5/16

(52) U.S. Cl. 428/90; 442/370; 442/373

(57) ABSTRACT

The apparel is constructed from various combinations of layers of materials with moisture transfer properties. A first liner of moisture transfer fabrics abuts a second layer of structural material such as foam. The second layer can abut a breathable membrane and/or an insulating material. Finally, carefully selected outer fabrics complete the combination to provide apparel with improved performance characteristics. The outer fabrics are treated in various ways to enhance performance.

CROSS-REFERENCE TO RELATED APPLICATIONS

This is a continuation-in-part application of U.S. Ser. No. 08/910,115, filed Aug. 13, 1997, which is a continuation-in-part of U.S. Ser. No. 08/832,815, filed Apr. 4, 1997, which is a continuation-in-part application of U.S. Ser. No. 08/747,340, filed Nov. 12, 1996. Priority is claimed from Provision Application No. 60/559,009, filed Apr. 5, 2004.

### FIELD OF THE INVENTION

The present invention relates to apparel (garments) which are particularly suited to transfer moisture away from an individual. Particularly, the present invention relates to apparel constructed according to a moisture transfer system having a combination of layers that removes moisture away from an individual while also being comfortable and aesthetically pleasing in appearance.

### BACKGROUND OF THE INVENTION

Various types of apparel are known in the prior art. However, none of these provides the advantages provided by the present invention. In particular, the types of apparel known in the prior art do not take advantage of the new advances in materials and fabrics that have been made in recent years. Additionally, new apparel known in the prior art do not teach a moisture transfer system based upon specific combinations of layers as taught in the present invention.

### SUMMARY OF THE INVENTION

The present inventor has recognized the deficiencies in the apparel known in the prior art and has designed new apparel that is capable of overcoming those deficiencies. More specifically, the present invention discloses a carefully selected combination of layers of specific materials that enable moisture transfer, while at the same time providing comfort to the individual wearing the apparel.

An object of the present invention is to provide apparel that can quickly transfer moisture away from an individual's body so that the individual can feel more comfortable.

Another object of the present invention is to provide individuals involved in activities such as in-line skating, snowboarding, hiking, etc. with active wear that is more functional and can better deal with additional moisture that is generated by such individuals while involved in such activities.

Yet another object of the present invention is to provide a combination of foam-like materials and fabrics-like materials resulting from the latest technological advances in a manner unknown in the prior art.

These and other objects, features, and advantages of the present invention will become more apparent in view of the following detailed description of the preferred embodiments in conjunction with the drawings.

### BRIEF DESCRIPTION OF THE DRAWINGS

FIG. 1 generally illustrates the layers forming the combination according to an embodiment of the present invention.

FIGS. 2-6 illustrate various applications of the different combinations of materials utilized according to the present invention.

### DETAILED DESCRIPTION OF THE PREFERRED EMBODIMENTS

A detailed description of the preferred embodiments will now be included in conjunction with the Figures. It should be understood that these embodiments are set forth for purposes of explanation only and are not to be interpreted as the only application of the present invention.

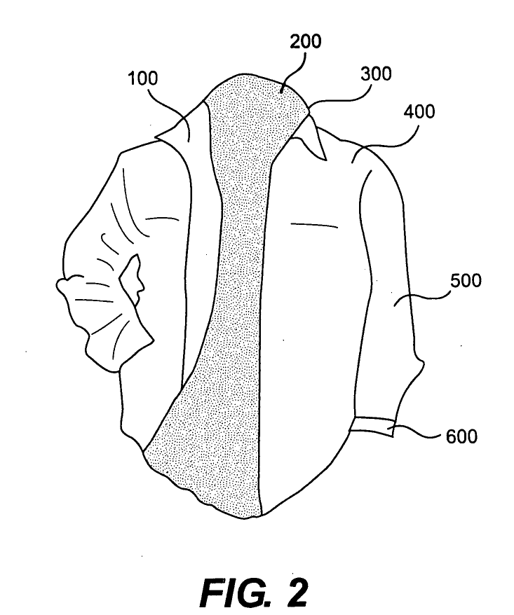

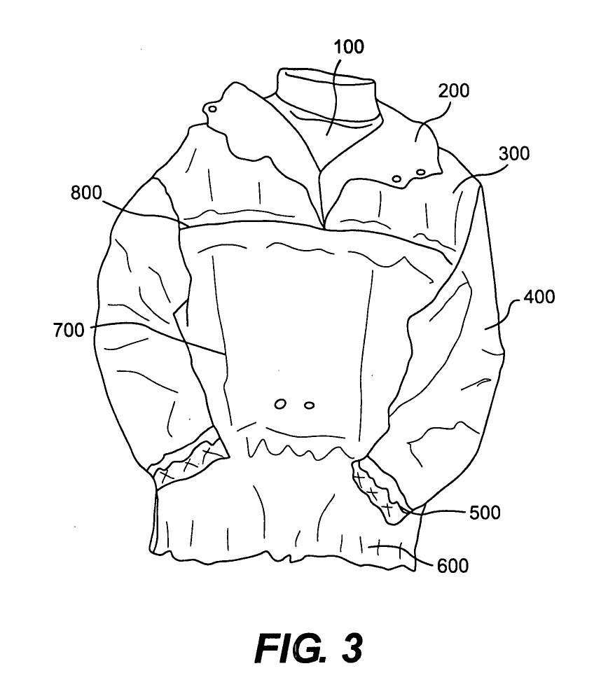

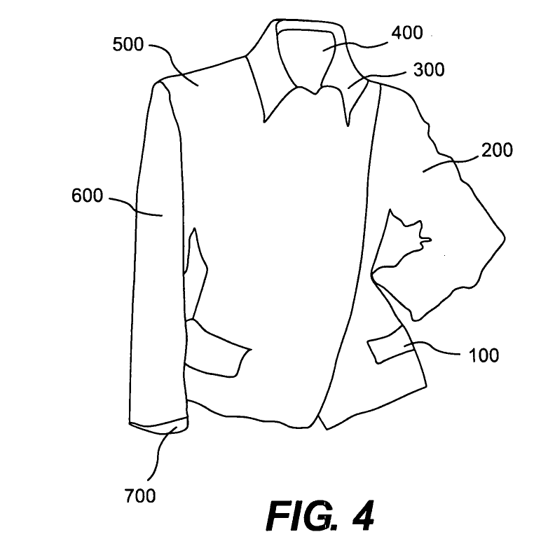

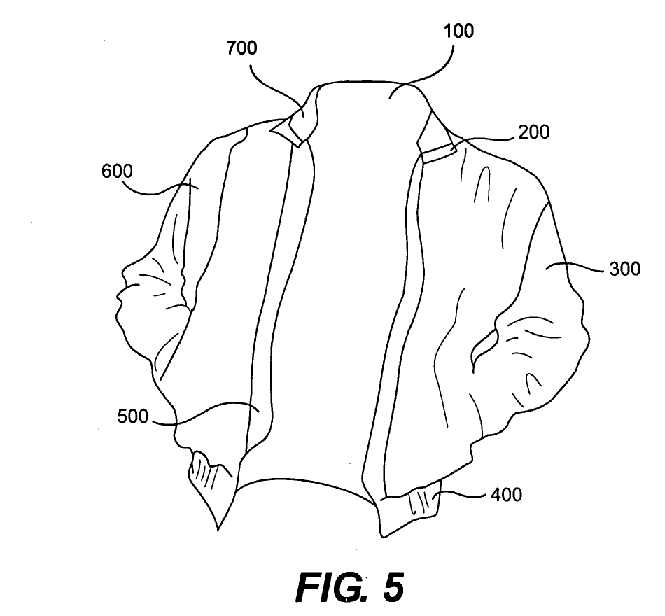

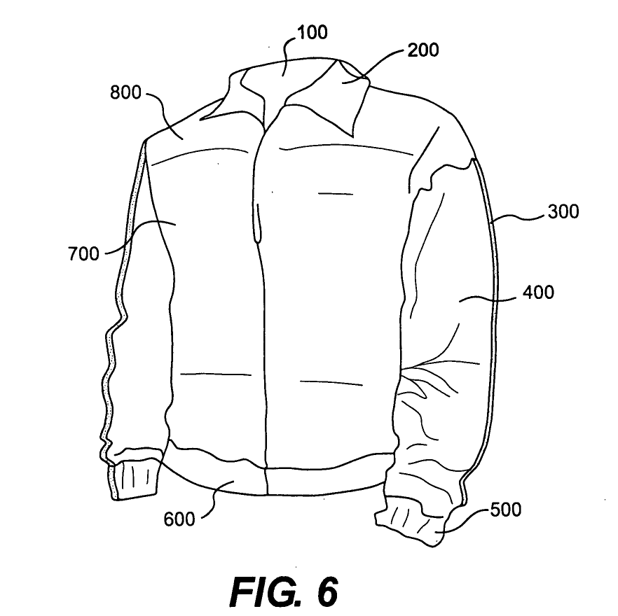

The apparel illustrated in FIGS. 2-6 includes shirts and jackets. Although not specifically illustrated, all of the types of apparel can be manufactured according to the present invention. The application of this invention to other types of apparel could easily be accomplished by one with ordinary skill in the art.

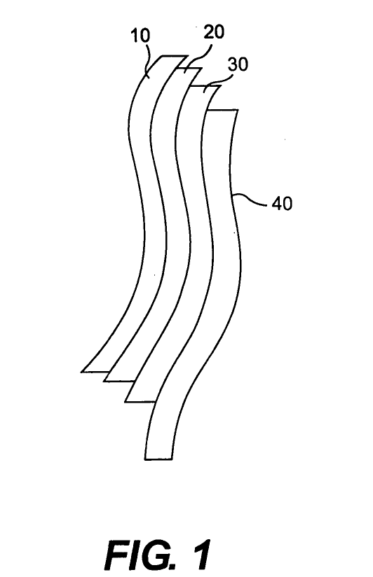

FIG. 1 generally illustrates the three layers that are a result of a preferred embodiment of the present invention, namely a first (inner) layer 10, an second layer 20, a third layer 30, and a fourth (outer) layer 40. These layers are attached to each other either by an environmentally friendly adhesive, mechanical bonding (or stitch bonding, such as that performed by Tietex, Inc., or Xymid Group of DuPont®), lamination (flame lamination, for example), welding or a combination of these three. Alternatively, a group of selected nonwoven synthetic or natural fibers blends may be flocked into the open cell, elastomeric composite or spacer fabric in the layer 20, 30 or the fibers may be flocked to the back side of the inner lining fabric or material or the outer shell exterior fabric or material. Mechanical bonding can be performed using nylon, elastine or LYCRA® thread or the fibers inclusive in the nonwoven structure or the like. Other equivalent methods may also be employed. Furthermore, as mentioned later, if encapsulation technology is used for the materials used as the fourth layer 40, then the fourth layer 40 is preferably not laminated to the third layer 30. This is due to the nature of encapsulated materials. In some performance categories layer 20 or 30 maybe eliminated. The invention may have additional layers added between layer 10 and 40 to accommodate the performance categories or the layers may be comprised of composites with additional layers.

A detailed discussion of the materials preferably used in these layers follows.

The first suggested fabrics for layer 10 are polyester or polypropylene fabrics or fabric blends made by Coville, Inc. or Deercreek Fabrics. These fabrics maybe are treated with TRANSPOR DRY FIBER TECHNOLOGY, a wetting solution or the like to enhance the moisture vapor transfer (MVT) properties.

The second fabric is an anti-microbial, anti-fungal polypropylene fleece having a polyester, cotton, acrylic, rayon or wool backing, or the like (such as that manufactured by Coville, Inc.). This double-sided fabric combines two moisture management mechanisms, wicking and absorption. The wickable synthetic fiber pushes the moisture away and the cotton, rayon, etc. pull the moisture up from the inner layer and spreads it out for transfer and evaporation. This double-sided fabric may be used for winter hiking or climbing boots and various alpine boots, the backing made of polyester or cotton blends can be replaced with either natural or synthetic blends of fibers such as wool, cotton, silk, acetate, acrylics, tencel, rayon, polyester, corn, kapok fibers or the like.

The third fabric may be a nonwoven such as that made by Freudenberg called VILDONA or EVOLON made from microdenier polyester, nylon synthetic blends or nonwovens made of natural fibers and natural fiber blends such as cotton, kapok, wood pulp and by-products such as those by NatureWorks called (PLA)CORNUCOPIA made from a corn fiber.

The fourth fabric is an anti-microbial, anti-fungal polypropylene/cotton blend or polyester and cotton.

The fifth fabric is a FIELDSENSOR polyester with waffle weave construction (such as that manufactured by Toray and distributed by Yagi & Co., Inc.). Alternatively, a polyester material known as AQUA-DRY, manufactured by Teijin Shojin can be employed.

The sixth fabric is a hydrophilic anti-microbial DRI-LEX BABY KID, DRI-LEX nylons or perforated material (such as that manufactured by Faytex Corp.).

The seventh fabric is a polyester looped terry (such as that manufactured by Kronfli Spundale Mills, Inc.).

The eighth fabric is a sueded/sanded fleeced polyester microfiber material (distributed by Yagi & Co., Inc. and Teijin Shojin, Inc.).

The ninth fabric is POLARTEC SERIES 100, 200 and POLARTEC POWERSTRETCH which is a wickable, moisture transfer fiber, containing LYCRA® and polypropylene. This fabric is also anti-microbial.

The tenth fabric is a moisture transfer fabric CERAMIC FLEECE by Calamai.

The eleventh fabric is a wool blend with a cotton, polyester, or the like backing.

The twelfth fabric is an acrylic-based conductive fabric from Sterling Performance.

The thirteenth fabric is a nylon or nylon polyester blend possibly treated with TRANSPORT DRY FIBER technology manufactured by Gilford Mills.

The fourteenth fabric is a spacer fabric constructed of nylon, polyester, or polypropylene blend.

The fifteenth type of fabric is selected chemical and naturally ionized synthetic fabrics and fibers such as (MICROSAFE ACETATE, MICROSUPREME ACRYLIC CYSTAR, BIOFRESH and the like manufactured by Celanese Acetate, Sterling Performance Fabrics, MICROSUPREME HIGH TECH ACRYLIC by Sterling Performance Fabrics.

The sixteenth type of fabric is ACRILLIAN or DURASPUN acrylics performance fabrics by Monsanto or blends of acrylics and polyester by Glenoit, or the like.

The seventeenth fabric is a blend of performance fibers and TEFLON or FREELON blend of Friction Free Technology by Concept III.

The eighteenth fabric is a new blend of corn fabrics or corn and cotton fibers with wool by Draper Knitting.

The nineteenth fabric is peppered fleece, a combination of cotton, acrylic or cotton, acrylic and polyester

The twentieth fabric is KWILL fleece by Concept III.

The twenty-first fabric is K-WICK by Kronfli Spundale Mills.

The twenty-second fabric is MICROLANA MICROFABRIC by Glenoit.

The twenty-third fabric is MICROSUPREME HIGH TECH ACRYLIC by Sterling Performance Fabrics a blend of acrylic, cotton and polyesters fleeced fabrics.

The twenty-fourth fabric is NANO-DRY by Burlington Fabrics or a blend of cotton and synthetics with NANO-Dry.

The twenty-fifth fabric is DRI-RELEASE by Concept III Textiles.

The twenty-sixth fabric is DYERTECH by Dyersburg.

The twenty-seventh fabric is DRYLINE by Milliken, a hydrophobic polyesterand LYCRA®.

The twenty-eighth fabric is SWEET a polyester fabric by Tapetex.

The twenty-ninth fabric is a polyester and polypropylene fabric blend by Coville, preferably COMFORTREL. Also preferred are moisture transfer knits by Coville and blends of cotton and polyester and/or polypropylene, preferably HIGHLANDER-PLUS or POLYGON STRETCH.

The thirtieth fabric is cross-dye POWER DRY and SMART FIBER fabrics by Wellman.

The thirty-first fabric is MICROMOVE by Burlington.

The thirty-second fabric is polyester fabrics and blends by Kronfli.

The thirty-third fabric is M.C.S. with NANO DRY.

The thirty- fourth fabric includes the Schoeller DRY SKIN and other inner lining Schoeller fabric or nonwoven materials.

The thirty-fifth fabric is a spacer fabric by Schoeller, NAM-LION G or the like.

The thirty-sixth fabric is COMFORETEMP or EVOLON blend nonwoven by Freudenberg.

The thirty-seventh material is a cellular elastomeric composite with stretch fibers.

The thirty-eighth fabric is a MVT THERMAL manufactured by Foss Manufacturing, a needle punch combination of nonwoven fibers and foam.

The thirty-ninth fabric is a MVT THERMAL with wool fibers.

The fortieth fabric is a flocked fabric with a knitted, woven or nonwoven face and a flocked fiber backing.

The forty-first material is a CHAMELEON or MVT THERMAL by Baychar Inc. The CHAMELEON composite is a bi-component composite. The CHAMELEON composite is breathable, capable of transferring moisture and optionally can be antimicrobial, thermal and waterproofed. The CHAMELEON composite is comprised of nonwoven fibers and foam mechanically bonded or fused. This is a single-layer bi-component composite and can be use as an end-use product or combined with other selected foam, nonwoven, knit or woven materials to develop end-use composite products. The CHAMELEON composite may alternatively increase thermal properties and moldable benefits when necessary in technical product lines.

The MVT THERMAL is mechanically bonded, bi-component nonwoven composite. The MVT THERMAL composite is comprised of a top sheet breathable layer of moisture transfer fibers mechanically bonded to a layer of open cell foam and a third layer of moisture-transferring and breathable fibers. The MVT THERMAL composite is anti-microbial, and thermally regulates temperature by using fibers, phase-change technology, or a combination of fibers and phase-change technology; The MVT THERMAL moisture transfer properties may be enhanced by adding surfactants, nanotechnology, shaped fibers or chemical ionization treatments. The MVT THERMAL may be used as a completed end use product or combined as a composite layer in end use product. Optionally, the MVT THERMAL may be waterproof with encapsulation, nanotechnology, membranes, coatings, waxes, chemical treatments or D.W.R finishes. This all-in-one MVT composite is moldable and able to adjust the thermal rating to accommodate the end use products. In some options, the first layer is comprised of a breathable MVT fiber nonwoven mechanically bonded to an open-cell foam layer and a nonwoven base fiber layer may be omitted to accommodate a technical advantage. The thinner MVT THERMAL composite combining the foam layer and nowoven fibers may have increased stretchability and MVT transfer rates.

Finally, spacer fabrics or fleeced fabrics of polyester or polyester blends manufactured by Malden Mills and others can be used. A large group of new technology inclusive of in fabrics and nonwoven is emerging into the technical textile industry. This invention includes MVT and enhancing technology incorporated in or on layer 10 through 40 or added to the surface of the technical fibers, fabrics and nonwovens of layer 10 through 40. Layer 10 may be treated with a chemical ionization, wicking solutions or a treatment such as COOLAN by KOLON TTA INC., or the like. The added option for an inner MVT fabric or nonwoven with Phase Change Technology (PCMs) or COOLON is an ionization chemical treatment. This positive charge or negative charge to the fabric or nonwoven layer develops an ideal performance product for extreme apparel.

The first layer 10 abuts a second layer 20 and is attached thereto by lamination, (adhesive or flame) mechanical bonding, ultra sonic bonding, breathable adhesives or the like. The second layer 20, in addition to its moisture transfer characteristics, provides some structural support for the apparel and can either be made of a single material or a combination of the materials as set forth below. The polymer web matrix or netting may abut or be included in any of the fabric or nonwoven selection in layer 10. Layer 10 may be backed by a flocked fiber selection with an environmentally safe adhesive. The flocked fabric or nonwoven presented in first layer 10 may be used in combination with the other layers in this invention or may comprise a complete product. Either layer 10 the inner lining material or layer 40 the exterior shell may have a flocked fiber backing and maybe used for a one layer product such as a jacket or shirt.

Second layer 20 may be one of twelve options. The first option for layer 20 is a reticulated, open cell foam or reticulated open cell hydrophilic foam. The foam is optionally backed with a non-woven top sheet made by DuPont®, Invista, Freudenberg, Alhstrom or the like, or a foam backed with a cellular elastomeric composite containing nonwoven fibers and foam or the like. The cellular elastomeric composite is disclosed in the eleventh option for layer 20.

The second option for layer 20 is a moisture transfer needle punch or dry-laid, wet-laid or polymer nonwoven. The nonwoven suggested in the first and second option transfers and absorbs moisture and is comprised of synthetic, natural fibers or a blend of these fibers. Silver fibers by Foss maybe added to the nonwoven top sheet or any layer in the invention. The non-woven top sheet may vary in composition as discussed above. The preferred composition for the top sheet is wood pulp, cotton, lyocel, rayon, polypropylene, elastine, or a stretch fiber such as LYCRA® (or a combination of two or more of these). Of course, the top sheet can contain one fiber and may be treated with Nano Technology or an ionizated solution. The top sheet is usually provided on one side of the foam, but can be provided on both sides of the foam or included in the foam, such as in extreme performance apparel, for example various types of climbing apparel. The foam can be of any thickness, preferably between 1/50 and 3/16″. The nonwoven top sheet abutting the foam or included in the foam may also be eliminated in some performance apparel options. Any nonwoven, spacer fabric or foam layer in this invention may be treated with PCM, Nano Technology, chemical ionization or a combination of these technologies.

The third and fourth option for layer 20 is a nonwoven with or without thermal characteristics. The nonwoven is formed by a dry-laid, wet-laid or polymer-laid method. The nonwoven may be a top sheet attached to the first layer 20 capable of absorbing and moving moisture with no thermal capacity or a thermal nonwoven. The thermal nonwoven alternative to the MVT composite system may be THERMOLITE, THINSULITE, SSOFTHERM, PRIMOLOFT, OUTLAST Technology nonwoven, Schoeller PCM nonwoven or a combination of one or more of these products with foam. Preferably, the thermal nonwoven and foam combination is a MVT THERMAL or CHAMELEON developed by Baychar Holdings. The MVT THERMAL is detailed in the eighth option for layer 20.

The fifth and sixth option for layer 20 is a spacer fabric or a spacer fabric and foam combination. The spacer fabric is constructed with two top sheets that are knitted, wovens, knitted-wovens, nonwovens or double-sided fabric or a combination of any of these selections on either side of a bed of continuous filaments. These top sheets may be combined with foam on either side of the bed. The sandwich construction produces a cushion-like material and provides rebound qualities to the MVT composite. The spacer fabric filament constructions in the top sheets on either side of the filament or the filament bed are shaped, hollow or smooth. In one example, the filaments are shaped 4-8 DG polyester fibers in both the top sheets and in the bed. In another example, the spacer fabric bed is a combination of hollow and shaped filaments. The top sheets located on either side of the bedding can be constructed of a number of combinations depending on the performance criteria required in the product. An alternative option to those the top sheets mentioned above is a cellular elastomeric composite placed on either side of the bed. The spacer fabric optionally is combined with a cellular elastomeric composite in a number of performance categories.

In option seven, a down feather layer may be combined with any of the layers suggested in layer 20. In fact, a down layer of feathers may be the insulated layer provided in a number of alpine solutions in this invention. The down layer such as that developed by NAPTURAL in France can be provide between layers 10 and 40 or may be used in combination with other composite constructions in this invention. The down layer may be alternatively treated with an ionizated chemical solution to increase the MVT performance.

The eighth option is a nonwoven and foam composite MVT THERMAL composite comprised of shaped 4-8 deep groove polyester, acrylic, polymer fibers, silver fibers, natural fibers or a blend and an open cell foam with or without PCMs technology, silica particles , air or gel spheres and anti-microbial properties. This MVT nonwoven and foam composite may include silver fibers by Foss Manufacturing and is manufactured under the tradename CHAMELEON or MVT THERMAL by Baychar Inc., and Foss Manufacturing. This all-in-one needle punch nonwoven product is thermally regulated by fiber content, silica, air micro-spheres, PCM Technology or a combination and transfers moisture immediately through the layers. The natural fibers such as wool, lyocel or a blend may be added to the MVT composite to increase the thermal and moisture vapor transfer. The MVT composite is quick drying and anti-microbial. The MVT THERMAL composite may be more or less thermal depending on the fiber content and foam selection, cell density and thickness and may include a cellular elastomeric layer needled into the nonwoven fiber layers. The cellular elastomeric, foam and nonwoven composite may include synthetic or natural fibers such as wool, cotton, acrylic, polyester, nylon, stretch fibers or the like as discussed above An acrylic web may be included in the MVT nonwoven composite on placed on the surface of the nonwoven composite with or without PCMs. The acrylic web may be further treated or include a number of wicking and thermal technologies to increase the performance of the MVT THERMAL or nonwovens layers in this composite and invention. Nano-Tex Technology can be added to this MVT THERMAL or to the CHAMELEON composite to increase the drying time. In a number of options the MVT THERMAL or CHAMELEON has mechanically bonded THEMOLITE, THINSULITE, COMFORTEMP or PCM nonwovens into the layers creating a range of thermal properties and values in the layered MVT system. The MVT THERMAL composite may be made comprised of wool, 4-8DG polyester, silver fibers and a blend of other natural synthetic fibers for all weather and hunting boots. The MVT THERMAL or CHAMELEON composite may be used in layer 1-4 in this invention and maybe be comprised of foam and nonwoven, nonwoven foam, nonwoven or foam, nonwoven and foam construction. This MVT composite is antimicrobial, MVT and can be more or less thermal with the addition of fiber, PCM or both. The MVT THERMAL anti-microbial composite may have NANO-TECHNOLOGY added to enhance the composite performance.

Layer 10, 20, 30 or 40 may be optionally a MVT THERMAL manufactured by Baychar Inc. and Foss Manufacturing or a combination of a MVT THERMAL and an elastomeric composite as suggested above in option eleven for layer 20. In some performance categories the inner lining material or fabric in layer 10 abuts a nonwoven and foam composite, a nonwoven thermal with PCM or the like or MVT THERMAL comprised of a thermal nonwoven and a foam mechanically bonded with or without PCM, air or silica spheres and the exterior shell fabric in layer 40. The performance apparel MVT composite system develops both a waterproof and moisture transferring sports application.

The ninth option for layer 20 is an elastomeric cellular composite by Foxrun Technologies. The elastomeric composite option is mentioned above in option one. The electrometric composite may abut layer 10 and the exterior shell layer in layer 40. This extremely thin composite creates an all-in-one product. A membrane may be included between the elastomeric composite and the outer shell fabric or material in layer 40 to waterproof the product or layer 40 may be treated with a waterproof breathable film or encapsulation to waterproof the product. Nano Technology may be added to the elastomeric layer or the membrane abutting the elastomeric composite or may be combined with the exterior shell fabric or nonwoven layer.

The tenth option for layer 20 is a MVT felted product comprised of natural, synthetic or a blended of fibers. The felted product may be used in layer 10, 20, 30. Silver fibers may be added to enhance thermal and anti-microbial properties. This antimicrobial, MVT felted liner can be more or less thermal with the addition of fiber, PCM or both.

The eleventh option for layer 20 is a cellular elastomeric option. This tissue thin cellular elastomeric composite can vary in fiber content and foam composition as mentioned above. The cellular elastomeric composite is extremely flexible and may include elastine or stretch fibers, silver fibers and numerous combinations of natural and synthetic fibers blends. The cellular composite may vary in thickness, stretch and in strength and may be a washable or a deposable product. The elastomeric composite is made of foam fused together with synthetic or natural or a blend of these fibers. The elastomeric composite can be applied in layer 10 through 40 and may have fibers flocked into either side of the elastomeric composite. Optionally, the elastomeric composite and foam and nonwoven composites may contain or abut a netting or acrylic web to provide strengthen, stretch, MVT and/or thermal enhancement. The polymer web or netting may abut or be included in any of the foam or nonwoven layers in this invention. Preferably, an acrylic web developed by Freudenberg is suggested in this selected performance option. The elastomeric composite may be or abut layers 10, 20, 30 or 40. The elastomeric composite may be positioned between layer 10 and 40 or may be a single layer product.

The elastomeric composite may be welded or quilted in this extremely thin 1-5 layer composite system for apparel or footwear products. This all-in-one thin MVT composite product may be wind and waterproof. The elastomeric composite layers may contain acrylic, wool, lyocel, polyester, stretch fibers. The liquid polymer fused together with water jet technology and fibers makes an excellent carrying agent for a number of particle-based technologies such as PCM, air spheres, silica or the like. The liquid polymer solidifies under pressure with the fiber base to a flexible substrate and develops numerous options for interlinings and commercial products. The cellular elastomeric composite is disclosed in U.S. Pat. No. 6,074,966, which is hereby incorporated by reference. This invention includes the former elastomeric composite invention by Foxrun and further invents the incorporation of Nano-Technology, Phase Change Technology, ASPEN air gel, chemically ionizated fibers and web matrix into the elastomeric cellular composite. The elastomeric composite maybe combined with the thermal nonwoven by mechanical bonding, lamination or welding. The elastomeric may be combined with a spacer fabric. The spacer fabric may have shaped fibers, hollow fibers, silver fibers, wrapped fibers or a blend. The spacer fiber may be treated with a chemical ionization to increase the MVT properties in the composite. The spacer fabric may be used by it self in any layer or in combination with any layer in this invention and especially in combination with a foam, a cellular elastomeric or a nonwoven. The spacer fabric may be combined with MVT THERMAL nonwoven, the Freudenberg COMFORTEMP nonwoven, PCM nonwoven, Nano-Technology, PCM technology, a membrane or coating.

All the foam materials discussed herein are preferably AQUAZONE or VPF made by Foamex, or the like or the foam layer may be an open cell frothed foam. The foam layer may be any layer or applied to any layer in this invention. In some performance categories the frothed foam may be combined with a polymer mesh to enhance product performance. The open cell foam or frothed foam may add natural or synthetic fibers, a netting, polymer web matrix, PCMs, silica powder, air spheres, Nano-Technology or air gel technology spheres by ASPEN or the like. ASPEN air gels and Nano-Technology can be added to any fiber, fabric, foam, spacer material or nonwoven in this invention to increase the insulated values, MVT performance or waterproofing characteristics in the composite. The frothed foam when selected for layer 20 or 30 may be combined with natural or synthetic fibers and in some cases with a netting or web technology or a waterproof membrane or film. The membrane or film are optional and are used to waterproof the product when necessary. The membrane is eliminated in a number of performance categories if the outer shell fabric or nonwoven material is encapsulated by Nectex, Toray, Kolon or the like or is knitted-wovens treated to repel water or if the NANOSPHERE Technology has been added to waterproof the exterior shell in layer 40. A waterproof membrane or film may be combined with the exterior fabrics or nonwovens containing Nano-Technology, encapsulated technology or waterproof knitted-wovens layer in the MVT system in some exterior performance apparel and footwear applications.

A number of patents have been issued to Triangle Research & Development Corp. disclosing details related to the processes now being employed by Gateway Technologies and Schoeller Textil, Freudenberg COMFORTEMP, OUTLAST Technology, and Invista. For example, U.S. Pat. Nos. 4,756,958 and 5,366,801 are directed to fibers and fabrics with reversible enhanced thermal properties respectively. The disclosures of these two patents are hereby incorporated by reference. Other patents assigned to Triangle Research and Development Corp. that are related by subject matter and have overlapping inventorship, include U.S. Pat. Nos. 5,415,222, 5,290,904, and 5,244,356. These patents are also hereby incorporated by reference.

The twelfth option for layer 20 is a flocked fiber composition. One preferred option is a composed of polyester or shaped polyester fibers and a synthetic and natural fiber blend manufactured by Foss Manufacturing and Claremont Flock. The flocked fiber blend with or without silver fibers can be applied to any layer in this invention to increase the MVT and thermal options in each layer. The silver fibers are anti-microbial and thermal. The flocked fiber composite added to the back side of the inner layer fabric may abut layers 20, 30, or 40 or the flocked fiber combination maybe be added between layer 10 and 40 comprising a extremely thin composite apparel. The layers in the invention may be eliminated or combined in some performance categories with the flocked fiber composition. For example, the inner lining MVT material may be flocked on the back and layer 40 may be welded, mechanically bonded or laminated to layer 10 creating a MVT system and product. The flocked fiber MVT blend may be flocked to any layer in the MVT system including nonwovens, films and membrane surfaces or the flock may be applied to the actual fiber filament. In some performance categories the flocked MVT layer may be included as an inner layer in a fabric, foam, membrane, film or a nonwoven. In one example, a bed of nonwoven fibers are laid down and a flock MVT fiber blend applied to the surface of the nonwoven base. A second layer of nonwoven fibers are then applied by mechanical bonding, adhesive or fused to the base layer creating a flocked fiber composite with nonwovens. A similar layer of flock MVT fibers can be added to frothed foam base and the second foam layer applied after the fibers have been added to the base foam. The addition of a flocked fiber blend to an internal matrix web enhances the MVT performance and increases the waterproof attributes of a product. The flocked MVT fibers may a natural or synthetic or a blend of fibers. The flocked fiber blend may contain wrapped fibers, hollow fibers, shaped channel fibers such as 4 to 8 DG polyester or polymer fibers. The MVT flocked blend may contain a number of enhancing additives such as silica powder, air spheres, microspheres with PCMs Phase Change Technology), ionized particles. The MVT flocked fiber blend may be treated with an ionized solution to enhance the MVT properties or NANO-TEX or NANO-DRY. The flocked MVT composite is especially recommended for a single layer exterior shell woven or knit fabric or nonwoven. The flocked composite with an environmentally friendly adhesive is applied to the inner side of the single layer. The one layer MVT composite fabric, material or nonwoven is an all-in-one product and is used for shell garments and performance apparel, activewear, footwear, helmet liners, shoulder strips, back packs or the like. A preferred thermal MVT flocked blend for a one layer shell construction is a wool, lyocel and 4DG polyester with or without silver fibers. A waterproof application or treatment to the exterior shell fabric or material makes this all- in-one MVT composite with an environmentally friendly, breathable adhesive is waterproof, thermal, MVT, antimicrobial and extremely light and flexible.

If desired, a membrane, film or coating with or without PCMs, Nano-Technology air spheres, or gel spheres may be laminated between the first layer 10, and the second layer 20. Layer 20 and third layer 30 or third layer 30 and the fourth layer 40. Layer 30 may be a membrane in some performance categories. A coating with microscopic acrylic PCMs, gel or air spheres or the like may be added to the coating and included in the nonwoven or foam in layer 20 or 30. A polymer or foam coating with or without PCMs, air, gel, silica, spheres, MVT enhancements optionally can be applied to the fibers in the nonwoven or fabric layers in any layer in the composite system. The foam enhancing treatment may be applied to foam, nonwovens, synthetic or natural fibers or to the fabrics in this system by Hydrophilix Inc. The Hydrophlix foam application may be applied to the back of the inner or exterior shell fabric or nonwoven. Alternatively, an acrylic web matrix or an acrylic or polymer dot matrix maybe applied to a layer of nonwoven or foam, the MVT THERMAL, or spacer fabric or spacer fabric and nonwoven in layers 20 or 30 or added to the back of the MVT fabric in layer 10 or exterior shell fabric in layer 40. The acrylic dot matrix is a carrying agent for PCMs air spheres, gel or MVT enhancement materials or treatment or the like and increases the flexibility and strength of a layer and performance attributes of the MVT composite system. All fibers, fabrics, foams and nonwovens can be treated with a wicking solution to increase the moisture transfer properties and characteristics.

The OUTLAST membrane with PCM Technology, PCM in a binder or frothed foam with PCMs disclosed by Gateway Technologies may be laminated or incorporated with the foam, nonwoven or fabric or the PCM Technology may be embedded in the AQUAZONE, open cell foam, nonwoven or the like., COMFORTEMP Technology, SCHOELLER, PCM Technology and OUTLAST Technology are microencapsulated technology which depending on the application can provide either warming or cooling. If Schoeller Technologies is selected, hydrophilic foam is used in the layer 20 and is referred to as COMFORTEMP or PCMs. COMFORTEMP may be a foam layer or a nonwoven layer with PCMs. The COMFORTEMP nonwoven is manufactured by Freudenberg and may be an option in any layer in this invention or combined with any layer in this invention. This invention employs VPF or AQUAZONE, or a hydrophilic/open cell foam may also be used and may be laminated to the OUTLAST membrane, coating or the like. The foam may be or may not be embedded with the PCM Technology or natural and synthetic fibers.

The addition of the Phase Change Technology to melt blown nonwoven fiber is presently marketed by OUTLAST as THEMOCULE or by Freudenberg as COMFORTEMP Nonwovens or by Schoeller Textil as PCM. The PCM nonwoven developed by Schoeller, Freudenberg or OUTLAST or Invista can be used in any layer in this invention or combined with any layer in this invention. The OUTLAST/Invista nonwoven with PCMs, Schoeller nonwoven or Freudenberg PCM, nonwoven thermal fibers with Phase Change, THERMOLITE with or without Phase Change Technology or THINSULITE with or without Phase Change Technology or THERMOSENCE by Wisconsin Global Technology or a down technical filling by NAPTURAL is an option in layer 20 or layer 30. Layer 30 maybe a thermal nonwoven such as THERMOLITE, THINSULITE or PRIMOLOFT or any insulated nonwoven product. In one option layer 30 has microspheres containing air in a binder applied to a nonwoven or fabric backing. All synthetics and natural fibers, fabrics and nonwoven layers in this invention may have the option to be treated with Phase Change Technology or a micro-sphere technology to increase the thermal properties in the fiber or layer. This invention is inclusive of any coating, additive, treatment or fiber that increases the thermal or MVT characteristic of the layers in the MVT system.

The MVT layered system disclosed as 1 to 4 layers may have additional layers or may be one layer with multiple functions. The addition of membranes or films as suggested or thermal nonwoven or foam layers may be applicable in the development for extreme apparel and footwear products. The MVT system may also be an all-in-one product layer described as a flocked fabric or material or a flocked thermal composite developing a single layer composite product. In one alternative the flocked fiber, antimicrobial blend is added to the back of an inner MVT fabric or material layer 10 or the back of an outer shell material or fabric layer 40. This one layer composite system is extremely thin and can be worn as a shirt, pants, jacket or the like. For example, in the water sports apparel category the exterior shell waterproof material may be backed with a flocked MVT THERMAL fiber blend and promote warmth and dryness in the inner atmosphere of the surfing or diving suit. The flocked fiber composite blend can be added to the encapsulated exterior shell denims, cottons, wools and wool blends, cordura nylons, stretch cordura or any inner lining or shell fabric or material. In fact, any structural knitted or woven fabric or nonwoven may have a MVT flocked system applied to one side or both, and these flocked fiber layer composites may be used as a completed product line or may be incorporated into this multi-layered MVT system. The flocked fiber blend incorporates a breathable and environmentally friendly adhesive. Optionally, this extremely thin composite MVT flocked layer may be applied to the back of any layer in the MVT system.

The combination of the foam and top sheet forming second layer 20 can be produced in at least three different ways. According to one way, second layer 20 is produced by laminating or welding a top sheet to the foam. According to another way, the second layer 20 is a cellular elastomeric composite in which the top sheet and the foam have been fused together by water pressure. If the elastomeric composite is used in layer 20, then it is suggested the composite be needled or welded to layer 10 or 30. A complete description of the elastomeric composite is disclosed in U.S. Pat. No. 6,074,966 and other patents and applications by Frank Zlatkus. In some options, layer 20 can be omitted and the MVT THERMAL or the foam abuts layer 40. All foam layers in this invention may add synthetic or natural fibers or a blend of fibers or mesh to increase performance properties.

Any layer in this invention can be omitted to accommodate the product criteria. Any layer in this invention can be chemically ionizated, treated with Nano-Technology to increase the MVT rates and drying rates. The exterior shell fabric is presented in the invention as waterproof, but in some performance categories waterproofing is optional.

The third layer 30 much as layer 20 may vary in material and composition with the performance criteria. Layer 30 may be a nonwoven, foam, nonwoven and foam composite, spacer fabric, spacer fabric and nonwoven or foam, an elastomeric composite, a membrane, film or the exterior shell fabric depending on the performance category. If the third layer 30 is a breathable membrane or film or includes a breathable membrane or film, it is preferable to select one of the suggested membranes or films: TX1540 by Shawmut Mills, SECO-TEC, THINTECH, LAYTEK, WITOFLEX SYMPATEX WINDLER, SYMTHETIC ELASTIC, ENDURANCE TRIAD, STORM TEX, ACCUVENT, eVENT, AQUAPHILE, Super Dry Film by Bazenden Chemicals (a water-based hydrophilic polyurethane membrane) membranes or films by Harrison Technology such as DURAPEL PLUS, TRAVTECH, HYPER DWR, ENTRANT G-XT OR eVENT FABRICS or the like. Nano-Technology may be included in layer 30 with the nonwoven or membrane.

The waterproof/breathable membranes may be combined with PCM, silica micro-spheres and acrylic micro-spheres with air, gel or the like. The breathable membrane or breathable films can be applied to any layer in the invention. The breathable membrane and films absorb the outgoing moisture and transfer it to the garment surface while providing a waterproof barrier for the garment. The membrane, coating or film is laminated to the inner side of the outer shell fabric, but can be applied to any layer in this invention when necessary. A film or coating maybe applied to the exterior shell fabric to provide waterproofing in the absence of the membrane or encapsulated fabrics. In some performance categories a membrane may be combined with a fabric that has been treated with a waterproof film or coating to increase the waterproof protection. If the outer fabric is encapsulated or structurally woven to repel water, the breathable membrane is not necessary. For colder conditions, such as for temperatures below 32° F., an additional insulating layer may also be provided along with the PCM membrane or coating. PCM Technologies can be applied to a coating or the surface of a membrane or film to increase the thermal performance. This insulating layer is preferably THERMOLITE thin or Extreme (manufactured by DuPont®), a hydrophilic foam with or with out PCM, with a spacer fabric or the MVT THERMAL. All layers and fibers can be optionally treated with a chemical ionization, an electrically charged solution to increase the MVT performance levels.

Preferably, the breathable membrane may be inserted between layer 30 and 40. The THERMOLITE line of nonwoven owned by Invista/Koch Industries can be treated with chemical ionization to increase the moisture transfer properties, and the PCM can be applied air or gel spheres or silica to increase the thermal capacity. THERMOLITE, 2000/PLUS/STANDARD/1300series etc., SSOFTHERM or THINSULITE can be needled laminated, or welded to the MVT THERMAL composite by Baychar and Foss Manufacturing. Alternatively, this layer, like others, can be omitted entirely in certain applications.

The fourth or outer shell layer 40 abuts either the laminated breathable membrane, breathable waterproof film, flocked fiber composite as mentioned above, a foam, a foam composite with fibers, mesh spacer fabric or a combination, a nonwoven or an insulating nonwoven, nonwoven and foam, a nonwoven with a polymer web or foam matrix with or without PCMs, a MVT THERMAL, SSOFTHERM both manufactured by Foss Manufacturing, the elastomeric composite material, a spacer fabric, a spacer fabric and foam composite, an adhesive, a film, or acrylic or polymer web matrix in the third layer 20 or 30. If the outer layer is a material that is encapsulated by Nectex, Toray or the like, or if it is a performance fabric such as DERMIZAX by Toray, or MICROFT, which is distributed by Teijin Limited, then the third layer 30 abuts the fourth layer 40, but is not laminated thereto. Technical textiles are continuously developing to include fiber treatments that waterproof the exterior shell materials and fabrics. This invention covers waterproof treatments and applications to the fabric, nonwoven or shell material , inner lining material abutting the exterior material, nonwoven or shell fabric or the inner layers of the nonwoven, material or shell fabric. The boundaries formerly defining a fabric or a nonwoven have begun to merge. Knits and wovens are made in one layer constructions. Nonwovens and fabrics wrapped included in or fused with foam and are defined as either a nonwoven or a material.

The following is a list of outer moisture transfer materials that could be used as the outer layer 40:

Cotton polyester blend with a breathable membrane (several choices);

Cotton blend encapsulated;

Cotton denim or Chino encapsulated;

Cotton denim or Chino waterproof breathable membrane;

⅔ ply Supplex encapsulated;

⅔ ply Supplex waterproof breathable membrane;

6-ply Taslan encapsulated/waterproof breathable membrane;

Tudor by Travis encapsulated/waterproof breathable membrane;

Mojave/Twister by Travis encapsulated/waterproof breathable membrane;

Cordura encapsulated/waterproof breathable membrane;

Micro-Technical II sanded or Micro-Technical III Sanded by Brookwood encapsulated or membrane;

Citation Sanded or Jet-Laund by Brookwood encapsulated or breathable membrane;

Encapsulated Supplex by Toray;

Dermizax fabrics by Toray;

Entrant Gil by Toray;

Super-microft distributed by Teijin Shojin or ASF;

Gymstar Plus by Unitika;

Tuflex-HR by Unifika;

Schoeller Dryskin;

Schoeller encapsulated fabrics;

Schoeller Dynamic Extreme;

Schoeller Keprotec;

Schoeller Dynatec;

Schoeller Keprotec with Inox;

Schoeller NanoSphere fabrics

Schoeller WB 400 fabrics

Schoeller Kevlar, Cordura or composites with foam, nonwovens or both and PCMs;

Nam Liong, Toray, Teijin Shojin exterior shell performance fabrics and materials;

Micro-polyester fabrics distributed by Teijin Shojin;

Structurally knitted acrylic wool, with or without encapsulation (made by Toray), distributed by Teijin Shojin or ASF Group, Kyodo Sangyo Co. Ltd. (a structurally knitted fabric that repels water);

Vinyl materials with a nonwoven backing and plastics fabrics, by Tessile Florentina, Baikfan, or Teijin Shojin, these groups include Errebi, 101659-01669-01676-1271, 57006-800, and 43005-870;

Somatex, which is a neoprene type of material that is breathable;

Darlexx, which is a LYCRA® type of material and is to be used in the underarm portions of certain apparel;

Kolon HIPAN-Coolskin;

GoreTex soft shell composites and fabric;

Schoeller PCM composite constructed of exterior shell fabric with or without Nano-Technology, PCM foam and a knitted or nonwoven top sheet, or Schoeller exterior shell fabrics, foam with or with out PCM and a nonwoven top sheet with PCM Technology;

Kolon HIPAN-THERMOSKIN or HIPAN-CLASSIC;

Hipora waterproof breathable fabric by Kolon;

Ripstop Hardline fabric; and

Wool and wool blends which include one or more of the following: acrylic, LYCRA®, polyester, cotton, lyocel and nylon. These fabrics are made of yarns and are hydrophobic. Wool and wool blends are provided by Euromotte, Inc. of Belgium, and/or Toray in Japan. These fabrics are pure wool, wool blends, or acrylics that are knitted with hydrophilic yarns so as to be waterproof. This is in effect an encapsulation process or treated with a Nano-Ttechnology.

Any fabric or nonwoven in the exterior shell layer can be treated with waterproofing by membranes, encapsulation, films, wrapped fibers, internal webs and/or Nano-Technology. Molecular Nano-Technology creates a chemical sleeve or framework around the fiber and enhances the selected performance criteria. The exterior fabrics or material may be waterproofed with the NANOSPHERE Technology by Schoeller Textile. The inner lining material or fabric MVT characteristics can be enhanced by NANO-FRY by Burlington Fabrics or NANO-TEX. The chemically developed sleeve or framework is molecular and may be created out of silicates. Nano-Technology may be applied to the molecular structure of a fiber. Additionally, Nano-Technology can be applied along a fiber in Nano Channels. Nano Channels are created to control the flow of minuscule amounts of fluid. The channels have elliptical edges which permit fluid to flow freely along the fiber enhancing the MVT rates. A transparent substance of silicon, silicon dioxide or glass is heated and applied to the fibers. The Nano-Technology maybe thermally sprayed. Inframat Corporation has developed a patented process for thermal spray of nano-structured, by which the nano-particles can be reconstituted into spherical micron-sized granular, that can be thermally sprayed. The Nano-Technology can be thermally sprayed to any layer in this MVT system and especially to exterior shell layer. The NANOSPHERE technology is self-cleaning and stain resistant. Incorporated by reference are patents by Inframat Corporation. Incorporated by reference is U.S. Pat. No. 5,004,643 further additional patents by Caldwell and Nectex patents on encapsulation fibers and fabric.

All of the above, used as fourth layer 40, are laminated with a breathable membrane, encapsulated, covered by a waterproof film, or are woven man-made fabrics structurally knitted or woven to repel water. The structurally woven or knitted fabrics do not require encapsulation or breathable membranes to waterproof the garment. The preferred waterproof fabrics are Microft by Teijin Shojin, Gymstar Plus and Tuflex-HR, both by Unitika, Ltd. Another preferable fabric is a structurally knitted acrylic or acrylic blends, which may be encapsulated and distributed by ASF and made by Toray, for example. A number of marketed waterproof exterior films could be added as an option for snowboard apparel, especially for areas covering an individual's knees, elbows, and buttocks area. These films (DWRs) are applied by fabric manufacturers themselves. This film may or may not be used with encapsulation but may be used in combination with the waterproof breathable membrane systems. High abrasive materials, preferably Kevlar Fabrics by Schoeller, may also be added along areas of pants, elbows, pocket lines, cuffs, and buttock areas.

All technical apparel will preferably have seams hot melted or adhesively sealed to prevent moisture from entering along stitching lines. The extreme apparel will add zipped underarm vents to aid in moisture release and will contain a hydrophilic open cell foam collar band and wristband covers by inner fabric selection to absorb excess moisture and transport it away from the individual. A rain gut along the front shirt zipper line may be added to aid in moisture transfer.

FIGS. 2-6 illustrate various applications of the present invention as contemplated by the inventor. These applications are discussed, by way of example only. More specifically, FIGS. 2-6 illustrate various styles of shirts/jackets incorporating the present invention in different combinations. The reference numerals 101-109 represent various areas of the different types of apparel constructed from the following combinations of materials. It is once again mentioned that OUTLAST can be combined with the materials listed below, although not specifically mentioned. In other words, OUTLAST or Frisby Technologies can be combined with the foam materials, the breathable membranes, the THERMOLITE, or any of the outer fabrics. OUTLAST or Frisby Technologies can also be combined with encapsulation, by Nextec, for use in the outer layer 40. Of course, OUTLAST or Frisby Technologies can also be used by itself.

Numeral 100 is preferably formed by a layer 40 formed from a cotton blend fabric that is encapsulated and may include denim and chino fabrics. Inside of layer 40 is a layer 20 which is a cellular elastomeric composite of a hydrophilic ⅛″ foam having a non-woven top sheet. Inside of layer 20 is a layer 10 of any of the inner liner materials listed above in connection with layer 10. According to this application, layer 30 is omitted.

Numeral 200 has a layer 40 of a cotton blend encapsulated THERMOLITE Extreme, Microloft, or the like, or hydrophilic/open cell foam or reticulated foam (either or in combination as a composite). Inside of layer 40 is a layer 20 which is a non-woven backed foam, the foam preferably being AQUAZONE. Inside layer 20 is layer 10 which can be any of the inner liner materials mentioned above in connection with layer 10. Layer 30 is omitted.

Numeral 300 has a layer 40 that is a cotton/acrylic/polyester blend. Inside layer 40 is a layer 30 which is a waterproof breathable membrane. Inside layer 30 is a layer 10 which is one of various inner liner materials. Layer 20 is omitted.

Numeral 400 has a layer 40 that is a cotton/acrylic/polyester blend. Inside layer 40 is layer 30 which is a waterproof breathable membrane. Inside layer 30 is a layer 20 which is either THERMOLITE or reticulated/open cell hydrophilic foam with or without Frisby Technology. If foam is used, AQUAZONE is preferred. Also, the THERMOLITE and foam may be combined. Inside layer 20 is layer 20 of one of the inner liner materials.

Numeral 50 has a layer 20 of 2/4 Supplex, 6-ply Taslan, Cordura, Micro-Technical II and III, Citation Sanded, Tudor, Mojave, Twister Travis Fabrics, Kevlar Fabrics, laminated breathable membrane or encapsulated outer fabrics. Inside layer 40 is a layer 30 of THERMOLITE. Instead of THERMOLITE, a reticulated/open cell hydrophilic foam may be used, or may be combined with the THERMOLITE. Inside layer 30 is a layer 20 of a cellular elastomeric composite. Inside layer 20 is a layer 10 of one of the inner liner materials.

Numeral 600 has a layer 40 of Gymstar Plus or Microft Super structural constructed water-repellent fabrics. Inside layer 40 is a layer 20 of a non-woven and foam composite with or without a breathable membrane 30 between layers 40 and 20. Inside layer 20 is layer 10 of one of the inner liner materials.

Numeral 700 has a layer 40 of Gymstar Plus, Super Microft, Tuflex-HR, THERMOLITE Extreme or hydrophilic foam or a combination of these. Inside of this layer 40 is a layer 20 which is a cellular elastomeric composite or a foam with a non-woven top sheet laminated thereto. A breathable membrane 30 can optionally be added between layers 20 and 40.

Numeral 800 has a layer 40 made of one of the possible fabrics mentioned above, except Gymstar Plus or Super-Microft waterproof breathable membrane. Inside layer 40 is a layer 20 which is a cellular elastomeric composite. Inside layer 20 is a layer 10 of one of the inner liner materials.

Numeral 900 has a layer 40 made of one of the possible fabrics mentioned above, except Gymstar Plus or Super-Microft waterproof breathable membrane. Inside layer 40 is a layer 30 of THERMOLITE or a layer 20 of reticulated or hydrophilic open cell foam with a nonwoven top sheet. Inside layer 30 or layer 20 is a layer 10 of one of the inner liner materials.

Numeral 1000 has a layer of MVT fabric backed by MVT flocked fiber bend abutting an exterior shell fabric or material. The exterior shell fabric or material is optionally waterproofed by encapsulation, membrane, film, internal web, matrix or coating.

Numeral 1100 has a MVT fabric or material abutting a MVT THERMAL or CHAMELEON composite and exterior shell fabric or material. The exterior shell fabric or material is optionally waterproofed by encapsulation, membrane, film, internal web, matrix or coating.

Numeral 1200 has a MVT fabric or material abutting elastomeric composite and a MVT THERMAL or CHAMELEON composite and exterior shell fabric or material. The exterior shell fabric or material is optionally waterproofed by encapsulation, membrane, film, internal web, matrix or coating.

Numeral 1300 has a MVT fabric or material backed by a flocked fiber blend and is a single performance layer apparel product.

Numeral 1400 has an exterior shell MVT fabric or material backed by a flocked fiber blend and is a single performance layer apparel product. This single layer exterior shell material or fabric may be waterproof.

Numeral 1500 has a MVT THERMAL first layer 10 and an exterior shell fabric.

Numeral 1600 has a MVT fabric or material in layer 10 abutting a MVT Thermal, CHAMELEON composite or a Freudenberg PCM nonwoven and an exterior shell mesh or fabric. The exterior shell may be waterproofed.

Numeral 1700 has a MVT fabric or material abutting a spacer fabric and exterior shell fabric. This exterior shell fabric may be waterproofed in some options.

Numeral 1800 has a MVT fabric or material abutting a spacer fabric, a foam and exterior shell fabric. This exterior shell fabric may be waterproofed in some options.

Numeral 1900 has a MVT fabric or material abutting a cellular elastomeric composite, a spacer fabric, a foam and exterior shell fabric. This exterior shell fabric may be waterproofed in some options.

Numeral 2000 has a MVT fabric or material abutting a MVT THERMAL composite, spacer fabric and exterior shell fabric. This exterior shell fabric may be waterproofed in some options.

Numeral 2100 has a MVT fabric or material abutting a foam, MVT THERMAL or Freudenberg nonwoven composite, spacer fabric and exterior shell fabric. This exterior shell fabric may be waterproofed in some options.

Numeral 2200 has a MVT fabric or material abutting a foam, MVT THERMAL or Freudenberg nonwoven, spacer fabric, foam and exterior shell fabric. This exterior shell fabric may be waterproofed in some options.

The examples presented above illustrate how various combinations of the present invention can be realized on different parts in different types of apparel. Other variations are also possible given the range of combinations that are possible.

The microfiber technology disclosed above is rapidly developing and changing and has greatly increased the potential for improved performance of products such as performance apparel, provided that they are properly utilized as in the present invention. These new products are part of rapidly developing fabric technology. The present invention employs a combination of fabrics, foam layers, nonwovens, spacer fabrics, breathable membranes, encapsulated technology, structurally woven water repellent fabrics, or waterproof film coatings in such combinations that increase the performance of the products in which they are used as well as increased breathability. The breathable membranes have been also only recently developed and are believed to be less than ten years old.

While the present invention has been described above in connection with the preferred embodiments, one of ordinary skill in the art would be enabled by this disclosure to make various modifications to the disclosed embodiments and still be within the scope and spirit of the present invention as recited in the appended claims.

1. A moisture transfer apparel worn by an individual comprising, on at least a portion of the apparel, a combination of layers constructed as follows:
a first layer, closest to the individual, selected from a group of inner moisture transfer materials or fabrics;
a second layer, abutting the first layer, including a combination of a foam and a nonwoven material;
a third layer, abutting the third layer, selected from a group of outer shell moisture transfer materials or fabrics.

2. The moisture transfer apparel according to claim 1, wherein at least two of the first, second, and third layers are attached to each other by lamination.

3. The moisture transfer apparel according to claim 1, wherein at least two of the first, second, and third layers are attached to each other by ultra-sonic bonding.

4. The moisture transfer apparel according to claim 1, wherein the third layer is laminated to a breathable membrane.

5. The moisture transfer apparel according to claim 1, wherein the third layer is treated by encapsulation.

6. The moisture transfer apparel according to claim 1, wherein the third layer is coated by a waterproof film.

7. The moisture transfer apparel according to claim 1, wherein the outer moisture transfer materials are fabrics that are structurally knitted or woven to repel water.

8. The moisture transfer apparel according to claim 1, wherein the outer moisture transfer materials are fabrics that are coated with waterproofing thermal spray.

9. A moisture transfer apparel worn by an individual comprising, on at least a portion of the apparel, a combination of layers constructed as follows:
a first layer, closest to the individual, selected from a group of inner moisture transfer materials or fabrics; and
a second layer, backing the first layer, including a flocked moisture transfer fiber blend.

10. The moisture transfer apparel according to claim 9 wherein the first layer moisture transfer fabrics or materials and second layer flocked fiber blend abuts a third layer that includes outer shell moisture transfer materials.

11. The moisture transfer apparel according to claim 9, wherein the outer shell moisture transfer materials are fabrics are coated with a thermal spray.

12. The moisture transfer apparel according to claim 9, wherein at least two of the first, second, and third layers are attached to each other by lamination.

13. The moisture transfer apparel according to claim 9, wherein at least two of the first, second, and third layers are attached to each other by ultra-sonic bonding.

14. The moisture transfer apparel according to claim 9, wherein the third layer is treated by encapsulation.

15. The moisture transfer apparel according to claim 9, wherein the fourth layer is coated by a waterproof film.

16. The moisture transfer apparel according to claim 9, wherein the outer moisture transfer materials are fabrics that are structurally knitted or woven to repel water.

17. The moisture transfer apparel according to claim 9, wherein the outer moisture transfer shell materials are fabrics that are coated with a thermal spray.

18. A moisture transfer apparel worn by an individual comprising, on at least a portion of the apparel, a combination of layers constructed as follows:
a first layer, selected from a group of moisture transfer outer shell materials or fabrics; and
a second layer, backing the first layer, including a flocked moisture transfer fiber blend.

19. The moisture transfer apparel according to claim 18 wherein the first and second layers are combined with the third layer, closest to the individual, selected from a group of inner moisture transfer materials.

20. The moisture transfer apparel according to claim 18, wherein the outer moisture transfer shell materials are fabrics that are coated with a waterproofing thermal spray.
